(19) United States
(12) Patent Application Publication
(10) Pub. No.: US 2008/0037494 A1
(43) Pub. Date: Feb. 14, 2008

(54) Cell change in a communication system

(75) Inventors: Hannu Hietalahti, Kiviniemi (FI); Jarmo Virtanen, Espoo (FI); Antti Kangas, Oulunsalo (FI); Uwe Schwarz, Veikkola (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/882,222

(22) Filed: Jul. 31, 2007

(30) Foreign Application Priority Data
Jul. 31, 2006 (EP) 06118198.8

(51) Int. Cl. H04L 12/66; H04Q 7/24

(52) U.S. Cl. 370/338; 370/352

(57) ABSTRACT

The invention provides a method, system, and user equipment for requesting a call in a communication system. When sending a request for setting-up a packet switched call to a first network, a timer is started for waiting for a response to the request. When detecting a change from the first network to a second network, a request for setting-up a packet switched call is sent to the second network in response to the detection of the network change without waiting for expiry of the timer. The call can thus be setup with the second network with reduced time delay.

### FIELD AND BACKGROUND OF THE INVENTION

The present invention relates in general to communication such as mobile communications, and in particular to method, system and devices involved in handling e.g. packet-switched cellular mobile communications.

Generally, a variety of networks such as 3G (3^{rd} generation) networks allow packet-switched (PS) connections such as packet-switched (PS) calls or data connections. Such networks usually coexist with networks of other types such as circuit-switched, CS, networks, for example 2G (2^{nd} generation) networks.

Generally, if a packet-switched connection such as a PS call is requested in a cellular system, a PS domain link with required Quality of Service (QoS) is to be established. In a 3GPP (3rd Generation Partnership Project) system this means activation of a Packet Data Protocol (PDP) context. Depending on available capacity, a PDP context activation request under a Serving GPRS Support Node (SGSN) may lead to a downgrading of the requested QoS or a rejection of the request. In some cases, the mobile station may be located in an area where suitable neighbouring or overlapping cells or networks are under control of another SGSN. Such a case is given e.g. with GSM-WCDMA networks and dual-mode mobile stations. In some infrastructures, GSM (Global System for Mobile communications) and WCDMA (Wideband Code Division Multiple Access) cells are controlled by separate SGSNs (e.g. 2G/3G-SGSN). In a more general situation, if overlapping or adjacent cells are controlled by different network elements such as SGSNs and a service is requested which necessitates a handover to another network element, a service-based handover is to be performed.

In some cases, a connection or call having a desired parameter such as a desired PS QoS, may not be possible (e.g. due to congestion, system limitations, terminal limitations, etc) in the serving cell, i.e. in the cell where the calling or called terminal such as mobile stations camp, e.g. in idle mode, but may be provided in a neighbour cell or overlapping cell. This may typically be the case in multi-mode 2G-3G networks where the patches of 3G coverage completely overlap with 2G coverage. As an example, when a dual-mode terminal camping in GSM requests Voice-over-IP (VoIP), a conversational traffic class will be required. While the 2G network may not support this service, or may temporarily not have sufficient capacity available, it is likely that there is more capacity available in a 3G part of the same or another network. In such a case, an inter-system cell change may possibly be necessary.

### SUMMARY OF THE INVENTION

The invention provides a method, system, network element, computer program product, and semiconductor chip, as defined in the claims.

The invention provides the benefit of reducing a waiting time interval when setting up a packet switched connection such as a call.

The inventors have, among others, detected and solved the following problem. For example, when a User Equipment (UE) is moving, or handed-over, from one serving network element such as an SGSN to another serving network element during an ongoing Session Management (SM) procedure, a time delay may occur, as illustrated below, in particular with reference to FIG. 2.

The invention allows reduction or cancellation of the time delay occurring when the User Equipment (UE) should move or relocate from one network or support node such as SGSN to another during an ongoing Session Management (SM) procedure.

According to a standardized procedure, see 3GPP TS 24.008, a PDP context activation may be performed for establishing a PDP context between a mobile station, MS, or UE and the network for a specific QoS on a specific Network Service Access Point Identifier (NSAPI). For PDP context activation initiated by the mobile station, the MS sends an ACTIVATE PDP CONTEXT REQUEST message to the network, enters the state PDP-ACTIVE-PENDING and starts a timer T3380 which is set to 30 sec. Upon receipt of the ACTIVATE PDP CONTEXT REQUEST message, the network selects a radio priority level based on the QoS negotiated and may reply with an ACTIVATE PDP CONTEXT ACCEPT message. When receiving the message ACTIVATE PDP CONTEXT ACCEPT, the MS or UE stops the timer T3380, and enters the state PDP-ACTIVE. On expiry of the timer T3380, the MS resends the ACTIVATE PDP CONTEXT REQUEST and resets and restarts timer T3380.

Thus, also in the above described case of service based change to another cell, the current 3GPP implementation leaves the mobile station to await an expiration of the timer before re-initiating the PDP context activation request in case it has not yet received a PDP context activation request acknowledge message from the serving SGSN.

The present invention avoids this unnecessary waiting for those cases where the reason of not receiving any acknowledgement message is clear, such as inter-SGSN cell changes. A service based change to guarantee a requested QoS for a service that requires e.g. real-time or streaming class QoS, is very likely to lead to substantial rise in a service based change of cell, which implicitly is likely to lead to a change of SGSN, too.

According to the invention, a call request may be re-initiated as soon as possible when a change of the cell or serving network element such as SGSN is detected. There is no need to wait for the above mentioned expiration of a timer in the case of a relocation or handover such as an inter-SGSN cell change. The trigger for detecting such a relocation or handover can be e.g. a detection of a change of access technology (e.g. between 2G and 3G), such as a detection, by the UE, that it's radio parameters are being reconfigured, or a change of an area identity such as a Routing Area Identity (RAI) or Location Area Identity (LAI).

According to one or more embodiments, the invention provides at least one of a method, system, and user equipment comprising steps or features for performing at least one, some or all of the following: requesting a call in a communication system comprising at least a first network, including steps or means of sending a request for setting-up a packet switched call to the first network; starting a timer and waiting for a response to the request; detecting a change from the first network to a second network, or from a cell of the first network to a second cell; and sending a request for setting-up a packet switched call to the second network or second cell in response to the detection of the network or cell change before expiry of the timer. The first network may e.g. be a 2^{nd} generation network, and the second network can e.g. be a 3^{rd} generation network or a WLAN system. A controller of the first network may initiate the change to the second network when detecting that the first network cannot provide the requested packet-switched call. The user equipment can e.g. detect a change to the second network by detecting a radio channel reconfiguration, or by detecting a change of an area identity. The area identity can e.g. be a Routing Area Identity (RAI) or a Location Area Identity (LAI). The request for setting-up a packet switched call can e.g. be a message for activating a context such as an ACTIVATE PDP CONTEXT message for activating a PDP context. The request for setting-up a packet switched call can be sent by a user equipment such as a mobile station.

According to an embodiment of the invention, the UE, once it detects that its radio parameters are being reconfigured, decides that there is no point in waiting for the ACTIVATE PDP CONTEXT ACCEPT message, terminates the T3380 timer and sends a new ACTIVATE PDP CONTEXT REQUEST message immediately after the radio parameter reconfiguration.

The invention further provides a computer program product which is loadable into a user equipment. The computer program product may be stored on a data carrier or e.g. downloadable from a data base, e.g. via the Internet. The program controls the user equipment to perform, when loaded into the user equipment, in case of sending a request for setting-up a packet switched call to a first network; the step of detecting a change from the first network to a second network; and the step of immediately sending a request for setting-up a packet switched call to the second network in response to the detection of the network change. The request is thus sent even before expiry of a timer which may have been started when sending the request for setting-up a packet switched call to the first network.

The invention additionally implements a semiconductor chip for use in a user equipment, as defined in the claims.

The invention is also applicable in a case of a cell or network change from a cellular system to an alternative system, e.g. a handover to WLAN.

The invention is applicable when the first network is a 2^{nd} generation network, or a 3^{rd} generation network, or a WLAN system, or when the second network is a 3^{rd} generation network or a WLAN system, or a 2^{nd} generation network.

The invention can be used e.g. in case of a handover from 2G to 3G network and also in case of a handover from 3G to 2G network, or other cases of handover.

Further aspects, advantages and details of the invention will be described in the following.

### BRIEF DESCRIPTION OF THE DRAWINGS

FIG. 1 is a schematic overview showing the functional principle and structure of an embodiment of the present invention, wherein an inter-SGSN cell change is illustrated;

FIG. 2 shows a conventional message flow in case of an inter-SGSN cell change;

FIG. 3 shows an example of a message flow in accordance with an embodiment of a method, system, and user equipment according to the present invention in case of an inter-SGSN cell change; and

FIG. 4 shows an embodiment of a user equipment in accordance with an embodiment of the present invention.

### DETAILED DESCRIPTION OF EMBODIMENTS OF THE INVENTION

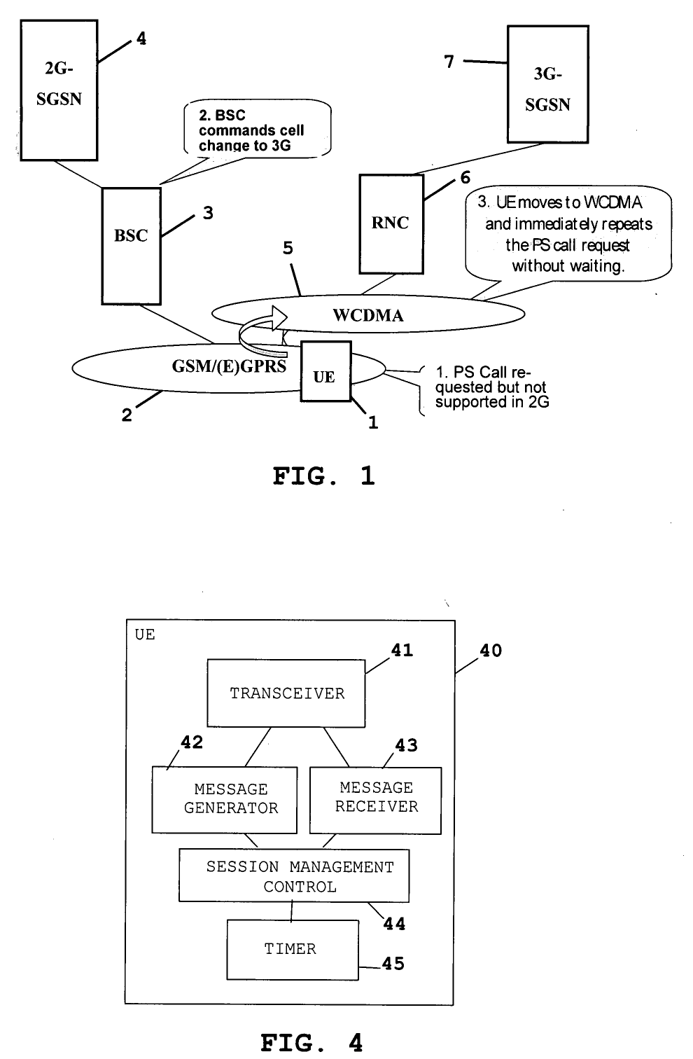

FIG. 1 is a schematic overview showing the functional principle and structure of an embodiment of the invention. A case of an inter-SGSN cell change is illustrated. A User Equipment (UE) 1, e.g. a mobile station, is registered in a GSM or (E)GPRS cell or network 2 under the control of a base station controller (BSC) 3 of a 2^{nd} generation (2G) network which comprises a 2^{nd} generation SGSN (2G-SGSN) 4. The user equipment 1 wishes to perform a PS functionality, e.g. VoIP call or video streaming session, which is, however, not supported in the 2^{nd} generation (2G) network. In a step 1, the UE1 request a PS call. BSC 3 detects lack of support of a PS call and commands, in step 2, a cell change to a 3G network or cell such as WCDMA 5. Instead of waiting for a predetermined timer value to elapse, the user equipment 1 immediately repeats, in a step 3, the PS call request directing the request to the WCDMA cell 5 under the control of a radio network controller (RNC) 6 of a 3^{rd} generation SGSN (3G-SGSN) 7 of a 3^{rd} generation network, as soon as it detects the BSC commanding a cell change to 3G.

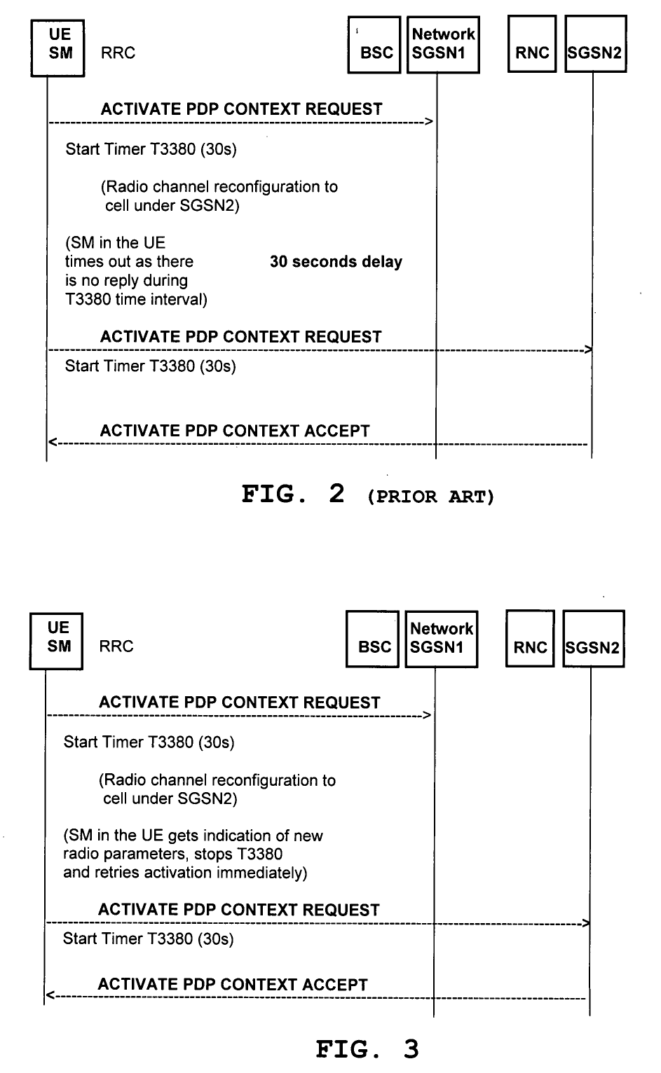

FIG. 2 shows the prior art message exchange necessary for an inter-SGSN cell change. The elements UE, BSC, SGSN1, RNC, and SGSN2 of FIG. 2 correspond to the elements UE 1, BSC 3, SGSN 4, RNC 6, and SGSN 7 of FIG. 1. The UE 1 includes a session management control SM. Further, a Radio Resource Control RRC is shown. As described above, the UE sends an ACTIVATE PDP CONTEXT REQUEST message to the network of SGSN1 4 via the base station controller BSC 3 and starts a timer T3380. Upon receipt of an ACTIVATE PDP CONTEXT REQUEST message, the network selects a radio priority level based on the QoS negotiated and may reply with an ACTIVATE PDP CONTEXT ACCEPT message.

If, however, SGSN1 4 belongs to a network incapable of PDP context, e.g. a 2G network, or is maybe in a busy state or otherwise non-available, the BSC 3 commands a Radio channel reconfiguration to a cell under SGSN2 7 belonging to another network capable of PDP context, e.g. a 3G network. Since the SGSN2 7 is not aware of the ACTIVATE PDP CONTEXT REQUEST that was received but not yet responded to by SGSN1, the UE 1 will not receive any acknowledgement message in the SM layer. Thus, the UE 1 simply waits for its timer T3380 to elapse ignoring the current cell change. Afterwards, assuming that SGSN1 4 is incapable of PDP context, is in busy state or otherwise non-available, the UE 1 sends a second ACTIVATE PDP CONTEXT REQUEST message to the network of SGSN2 7 via the radio network controller RNC 6, restarts its timer T3380 and waits for a ACTIVATE PDP CONTEXT ACCEPT message from the network of SGSN2 7 before commencing PDP context. Thus, a cell change is ignored, and some time of the predetermined timer value (e.g. 30 seconds in a 3GPP system) is wasted.

FIG. 3 shows a message exchange according to an embodiment of the present invention in case of an inter-SGSN cell change. The elements UE, BSC, SGSN1, RNC, and SGSN2 of FIG. 3 correspond to the elements UE 1, BSC 3, SGSN 4, RNC 6, and SGSN 7 of FIG. 1. The UE 1 includes a session management control SM. Further, a Radio Resource Control RRC is shown. As described with regard to FIG. 2, the UE 1 sends an ACTIVATE PDP CONTEXT REQUEST message to the network of SGSN1 4 via the base station controller BSC 3 and starts timer T3380. However, according to FIG. 3, instead of simply waiting for the timer T3380 to elapse and ignoring the cell change, when the SM layer or another component of the UE 1 gets an indication of new radio parameters, i.e. of a cell change, it stops its timer T3380 and retries an activation of PDP context immediately by sending the second ACTIVATE PDP CONTEXT REQUEST message to the network of SGSN2 7 via the radio network controller RNC 6. Afterwards, the process is the same as described in FIG. 2.

FIG. 4 discloses an embodiment of a user equipment 40 in accordance with the invention. The user equipment 40 comprises a conventional transceiver 41 for transmitting and receiving signals and messages (user traffic, signalling, etc), a message generator 42 for generating messages to be transmitted, such as context activation messages like Activate PDP Context requests, and a message receiver 43 for receiving messages via the transceiver 41, such as context activation messages like Activate PDP Context accept messages. Further, a session management control (SM) 44 and a timer 45 such as timer T3380 controlled by control 44 are provided. The SM control 44 controls the timer as described with reference to FIG. 3, and detects receipt of an indication of a cell change such as radio channel reconfiguration or change of an area identity. When detecting a cell change, the SM control 44 controls the timer 45, and the message generator 44 for immediately generating a context activation message like Activate PDP Context request in response thereto.

The SM control 44 may be implemented as a semiconductor chip which can be provided in or for a user equipment in an exchangeable or reprogrammable way for carrying out the invention.

Thus, the embodiments according to FIGS. 1, 3, and 4 provide a reduction of the response time for setting up a packet switched connection or call, e.g. setting up a context such as a PDP context, even in a case where ensuring a requested QoS requires a service based cell change. Compared to the prior art case in FIG. 2, the signalling according to the embodiment of FIG. 3 saves most of this timer value in real-time PS session setup, if a service based cell change is needed. All this time is visible for the user as PS session setup time. The session setup is hence accelerated.

A further advantage of the present invention is that no problems of backwards compatibility occur. The same serving network can handle both updated user equipments in accordance with the present invention, and customary legacy User Equipments. The main difference is experienced by the user in the PS call setup times.

Another advantage of the present invention is that the support of the feature can be observed in a system simulator by implementing a suitable test case that forces a cell change during PDP context activation requested by the UE.

Embodiments of the invention may thus comprise one or more of the following structures or features.

A user equipment is preferably suitable for use in a first mobile communication system comprising a first service-providing network element (2G-SGSN), a first controlling network element (BSC) and a first radio cell (GSM/(E)GPRS), and in a second mobile communication system comprising a second service-providing network element (3G-SGSN), a second controlling network element (RNC) and a second radio cell (WCDMA). The user equipment (UE) may comprise: generating means for generating messages needed for session management (SM) layer communications; transmission means for transmitting said messages needed for SM layer communications; reception means for receiving SM layer communication messages from the first and the second controlling elements of the first and second communication systems; timing means for measuring whether a predetermined time has elapsed or not; and detection means for detecting current radio parameters of the first and the second mobile communication networks. A change between the first and the second cell is performed by the user equipment transmitting by the transmission means a first request message to the first mobile communication system for setting up a service feature, conducting a cell change from the first cell of the first mobile communication network to the second cell of the second mobile communication network, wherein the user equipment normally waits for the predetermined time to elapse by means of the timing means before retransmitting by the transmission means the service request. When the user equipment detects, e.g. by the detection means detecting a change of the current radio parameters, that a cell change is about to be conducted between the first and the second cells of the first and second mobile communication networks, the user equipment does not wait for the predetermined time to elapse by means of the timing means, but retransmits by the transmission means the service request message immediately to the second mobile communication network, and waits by means of the timing means for an accept message from the second mobile communication network.

According to another embodiment, a control method is provided for controlling a user equipment suitable for use in a first mobile communication system comprising a first service-providing network element (2G-SGSN), a first controlling network element (BSC) and a first radio cell (GSM/(E)GPRS) and in a second mobile communication system comprising a second service-providing network element (3G-SGSN), a second controlling network element (RNC) and a second radio cell (WCDMA). The method may preferably comprise the steps of: generating messages needed for session management (SM) layer communications; transmitting said messages needed for SM layer communications; receiving SM layer communication messages from the first and the second controlling elements of the first and second communication systems; measuring whether a predetermined time has elapsed or not; and detecting current radio parameters of the first and the second mobile communication networks. A change between the first and the second cell can be performed by the user equipment transmitting by the transmission means a first request message to the first mobile communication system for setting up a service feature, conducting a cell change from the first cell of the first mobile communication network to the second cell of the second mobile communication network, wherein the user equipment normally waits for the predetermined time to elapse by means of the timing means before retransmitting by the transmission means the service request. However, when detecting, based e.g. on the current radio parameters, that a cell change is about to be conducted between the first and the second cells of the first and second mobile communication networks, the control method for controlling the user equipment does not wait for the predetermined time to elapse but retransmits the service request message to the second mobile communication network immediately, and then waits, starting the timing means again, for an accept message from the second mobile communication network.

According to a further embodiment, the invention provides a method for testing a user equipment, comprising the steps of: simulating a cell change; and observing a time delay between a first and a second request message.

Although preferred embodiments have been described above, the present invention is not limited thereto and intends to cover also all modifications, amendments, additions and deletions of features within the abilities of a person skilled in the art.

1. A method of requesting a call in a communication system comprising at least a first network and a second network, the method, comprising:
sending a request for setting-up a packet switched call to the first network;
starting a timer and waiting for a response to the request;
detecting a change from the first network to the second network, or from a cell of the first network to a second cell; and
sending a request for setting-up a packet switched call to the second network or cell in response to the detection of the network or cell change before expiry of the timer.

2. The method as claimed in claim 1, wherein requesting the call in the communication system comprises the first network comprising a 2^{nd} generation network, a 3^{rd} generation network, or a WLAN system.

3. The method as claimed in claim 1, wherein requesting the call in the communication system comprises the second network comprising a 3^{rd} generation network, a WLAN system, or a 2^{nd} generation network.

4. The method as claimed in claim 1, wherein detecting the change from the first network to the second network comprises initiating the change to the second network by a controller of the first network when detecting that the first network cannot provide the requested packet-switched call.

5. The method as claimed in claim 1, wherein detecting the change from the first network to the second network comprises detecting the change to the second network using a user equipment to detect a radio channel reconfiguration, or detecting a change of an area identity.

6. The method as claimed in claim 5, wherein detecting the change of the area identity comprises a routing area identity or a location area identity.

7. The method as claimed in claim 1, wherein sending the request for setting-up the packet switched call to the first network comprises activating a context with a message.

8. The method as claimed in claim 7, wherein sending the request for setting-up the packet switched call further comprises activating a packet data protocol context with an activate packet data protocol context message.

9. The method as claimed in claim 1, wherein sending the request for setting-up the packet switched call comprises sending the request by a user equipment.

10. The method as claimed in claim 9, wherein sending the request further comprises the user equipment comprising a mobile station.

11. A system for requesting a call in a communication system comprising at least a first network and a second network, the system, comprising:
transmission means for sending a request for setting-up a packet switched call to the first network;
timer means for starting a timer and waiting for a response to the request; and
detection means for detecting a change from the first network to the second network, or from a cell of the first network to a second cell;
wherein the transmission means for sending the request for setting-up the packet switched call is further configured to send a request for setting-up a packet switched call to the second network or cell in response to the detection of the network or cell change before expiry of the timer.

12. The system as claimed in claim 11, further comprising control means of the first network for initiating the cell change to the second network when detecting that the first network cannot provide the requested packet-switched call.

13. The system as claimed in claim 11, wherein the detection means comprises at least one user equipment for detecting the change to the second network by detecting a radio channel reconfiguration, or by detecting a change of an area identity.

14. A user equipment for requesting a call in a communication system comprising at least a first network and a second network, the user equipment, comprising:
a message generator configured to send a request for setting-up a packet switched call to the first network,
a timer configured to measure whether a predetermined time has elapsed and to wait for a response to the request, and
a session management control configured to detect a change from the first network to the second network, or from a cell of the first network to a second cell;
wherein the message generator is further configured to send a request for setting-up a packet switched call to the second network or second cell in response to the detection of the network or cell change before expiry of the timer.

15. The user equipment as claimed in claim 14, wherein the first network is a 2^{nd} generation network, a 3^{rd} generation network, or a WLAN system.

16. The user equipment as claimed in claim 14, wherein the second network is a 3^{rd} generation network, a WLAN system, or a 2^{nd} generation network.

17. The user equipment as claimed in claim 14, wherein the system management control is further configured to detect the change to the second network by detecting a radio channel reconfiguration, or by detecting a change of an area identity.

18. The user equipment as claimed in claim 17, wherein the area identity is a routing area identity or a location area identity.

19. The user equipment as claimed in claim 14, wherein the message generator comprises a message for activating a context.

20. The user equipment as claimed in claim 19, wherein the message generator further comprises an activate packet data protocol message for activating a packet data protocol context.

21. A computer program embodied on a computer-readable medium, the computer program being configured to control a processor to perform:
sending a request for setting-up a packet switched call to a first network;
starting a timer upon sending the request for setting-up the packet switched call to the first network;
detecting a change from the first network to a second network, or from a cell of the first network to a second cell; and
sending a request for setting-up a packet switched call to the second network or cell in response to the detection of the network or cell change before expiry of the timer.

22. A semiconductor chip for use in a user equipment, the semiconductor chip, comprising:
a logic circuit for detecting, in case of sending a request for setting-up a packet switched call to a first network, a change from the first network to a second network, or from a cell of the first network to a second cell; and for immediately sending a request for setting-up a packet switched call to the second network or cell in response to the detection of the network or cell change.
